(19) United States
(12) Patent Application Publication
(10) Pub. No.: US 2012/0129453 A1
(43) Pub. Date: May 24, 2012

(54) DOCK FOR GUIDING ORIENTATION OF A MOBILE PHONE FOR ENHANCED ACOUSTIC DATA TRANSFER

(75) Inventors: Chad G. Seguin, Morgan Hill, CA (US); Byron E. Alsberg, San Jose, CA (US); Brett L. Paulson, Palo Alto, CA (US)

(73) Assignee: Naratte, Inc., Sunnyvale, CA (US)

(21) Appl. No.: 12/953,376

(22) Filed: Nov. 23, 2010

(51) Int. Cl. H04B 7/00

(52) U.S. Cl. 455/41.2

(57) ABSTRACT

An acoustic dock for guiding placement and orientation of a mobile device for enhanced acoustic data transfer comprises a bottom surface; a plurality of sides attached to the bottom surface for receiving a mobile device having a transducer; and one or more transducers placed in proximity to at least one of the plurality of sides, where the acoustic dock is configured to assist orientation of the mobile device in the acoustic dock so that the mobile device transducer is adjacent to and in proximity to the one or more transducers of the acoustic dock to facilitate acoustic data communication.

### BACKGROUND

Over the years, technology has been developed for transmitting data over the air using an audio signal from a speaker, which may be referred to as acoustic communication. For example, in some type of systems, data is transferred over an audio signal of a television broadcast or a DVD movie to a user's mobile or handheld device for determining what program the user is viewing or for displaying additional information about the program. In another type of acoustic communication system, the presence of a user in a store is detected by continuously broadcasting an acoustic signal over a speaker in the store, which is then detected by an application running on the user's smart phone and reported.

While these systems are useful for their intended purpose, the above systems transmit data with an audio signal from a source, such as a television or a speaker, that is basically stationary during the transmission, and the data and audio are picked up by the microphone of a smart phone. Acoustic communication can become increasingly difficult, however, when attempting to transfer data from a source that is in motion, such as in a system where data exchange is transmitted acoustically through the air from a mobile device that is being held by the user, for example. In such a system, the user may rotate, shake, waive or generally move the device around such that device's speaker transmitting the audio and data is no longer aimed in the general direction of the microphone of the receiving device, hampering reception of the signal. The problem that can arise with acoustic data transfer in such an environment is the distance between the transducers of the transmit and receive device can become too large or the path between the two can become obscured, such that the acoustic signal cannot be received reliably.

Accordingly, it would be desirable to provide an improved acoustic data transfer method and system.

### BRIEF SUMMARY

The exemplary embodiments provide an acoustic dock that guides placement and orientation of a mobile device for enhanced acoustic data transfer. Aspects of exemplary environment include an acoustic dock comprising a bottom surface; a plurality of sides attached to the bottom surface for receiving a mobile device having a transducer; and one or more transducers placed in proximity to at least one of the plurality of sides, where the acoustic dock is configured to assist orientation of the mobile device in the acoustic dock so that the mobile device transducer is adjacent to and in proximity to the one or more transducers of the acoustic dock to facilitate acoustic data communication.

### BRIEF DESCRIPTION OF SEVERAL VIEWS OF THE DRAWINGS

FIG. 1 is a block diagram showing a top view of the acoustic dock.

FIG. 2 is a block diagram showing a right side perspective view of a right side of the dock.

FIG. 3 is a block diagram illustrating a partial isometric view of the dock and alternate microphone placement.

FIG. 4 is a block diagram illustrating a mobile device placed inside the dock in accordance with an exemplary embodiment.

FIGS. 5A-5BC are block diagrams illustrating alternative embodiments for the shape and configuration of the acoustic dock.

FIG. 6 is a block diagram illustrating an example usage of the acoustic dock in a point-of-sale environment.

### DETAILED DESCRIPTION

The exemplary embodiment relates to a method and system for providing an acoustic dock that guides placement and orientation of a mobile device for enhanced acoustic data transfer. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide a mechanical acoustic docking device that is designed to guide placement and orientation of a mobile device for enhanced acoustic transfer of data between a transducer of a mobile device and a transducer of a receive device.

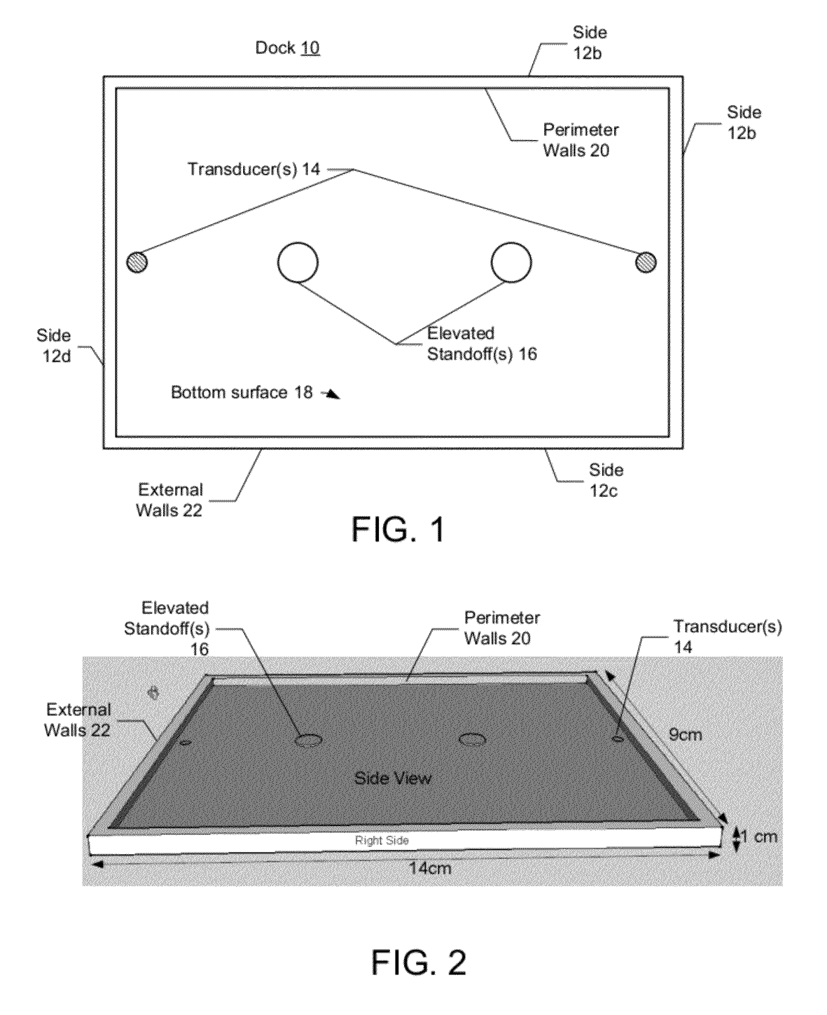

FIGS. 1-4 are block diagram illustrating various views of one embodiment of an acoustic dock system that is configured to assist or guide orientation and placement of the mobile device in the acoustic dock so that a transducer of the mobile device is stationary and in proximity to a transducer of a receive device when placed on or in the dock to provided improved over air reception of a modulated acoustic carrier signal sent between the mobile device and the receive device.

FIG. 1 is a block diagram showing a top view of the acoustic dock. FIG. 2 is a block diagram showing a right side perspective view of a right side of the dock. Referring to both FIGS. 1 and 2, according to the exemplary embodiment, an acoustic dock 10 for holding a mobile device is shown comprising a bottom surface 18 and a plurality of sides 12 that are attached to the bottom surface 18.

In one embodiment, the sides 12 may extend a vertical distance past the bottom surface 18 to form elevated interior perimeter walls 20 around the bottom surface 14, and external walls 22. The perimeter walls 20 may have several functions. For example, the perimeter walls 20 may act as a guide to the end-user for placement of the mobile device in the acoustic dock 10, and aid in retaining the mobile device once placed in the acoustic dock 10. In addition, the raised perimeter walls 20 may contain an acoustic carrier signal transmitted between the mobile device and the acoustic dock to enhance audio capture.

The size and shape of the acoustic dock 10 may vary, but the acoustic dock 10 overall provides guidance to the user on how to position their mobile device in the acoustic dock 10 to promote reliable acoustic data transfer. For example, FIG. 2 shows an embodiment where the bottom surface 18 and four sides 12 12a, 12b, 12c, 12d (collectively sides 12) are configured in an approximately rectangular shape, forming a receptacle that receives a rectangular device, such as a smart phone or a media device (e.g, an iPod Touch). Since the acoustic dock 10 is generally rectangular, the acoustic dock 10 has two long sides 12a and 12c and two short sides 12b and 12d.

In this specific embodiment, the short sides 12b and 12d may be approximately 9 cm in length, while the long sides 12a and 12c may be approximately 14 cm in length. The entire height of the dock may be approximately 1 cm. In one embodiment, the interior perimeter walls 20 may have an elevation of 5 mm from the bottom surface 18. In addition, in one specific embodiment, the standoffs 16 may be elevated approximately 2 mm from the bottom surface 18. According to the embodiment, the acoustic dock 10 further includes one or more transducers 14, such as transducer 14, placed in proximity to at least one of the sides 12 of the acoustic dock 10. An end user may not realize where the acoustic signal originates on their particular mobile device, and the acoustic dock 10 is designed to assist orientation of the mobile device so that mobile device transducer, e.g., speaker and/or microphone, is placed adjacent and in proximity to the transducers 14, e.g., microphone(s) 14 and/or speaker, of the acoustic dock 10 to facilitate acoustic data communication. When the mobile device is placed on the acoustic dock 10 and transmits an acoustic signal, for example, the acoustic dock transducer 14 (e.g., microphone(s)) captures the audio signal regardless of the orientation of the mobile device, thereby increasing effectiveness of acoustic data transfer.

Only one transducer 14 on the acoustic dock 10 is required for the data transfer to occur, however, the reliability of that transfer can be increased with additional transducers 14 since the user does not need to worry about top to bottom orientation of the mobile device in the acoustic dock 10. Multiple transducers 14 provide additional robustness to orientation mismatch. For instance, if the acoustic dock 10 has a microphone 14 at both ends, a mobile device with a speaker at one end only can be accommodated without needing to guide the user on how to position the mobile device.

According to one embodiment, the top of the transducer 14 may be made coplanar with the bottom surface 18. However, in an alternative embodiment, the transducer 14 need not be coplanar with the bottom surface 18.

According to a further aspect of the exemplary embodiment, the acoustic dock 10 is provided with one or more elevated standoffs 16 located on the bottom surface 18 that protrude upwards from the bottom surface 18 to provide an acoustical optimal gap between the mobile device and the bottom surface 18 of acoustic dock 10. The elevated standoffs 16 are generally located along a lengthwise center line of the acoustic dock 10 as shown. The elevated standoffs 16 may be designed to optimize the frequencies used for acoustic data transfer. The elevated standoffs 16 ensure that mobile devices having transducers flush to the surface of the mobile device are elevated to allow the acoustic signal to pass to the transducer 14 of the acoustic dock 10.

In one embodiment, the acoustic dock 10 may be made out of a non-porous, hard material with a high reflection coefficient. Example types of materials could include plastic, glass, wood, or metal. The material may be chosen to ensure the acoustic signal being communicated is not absorbed or attenuated.

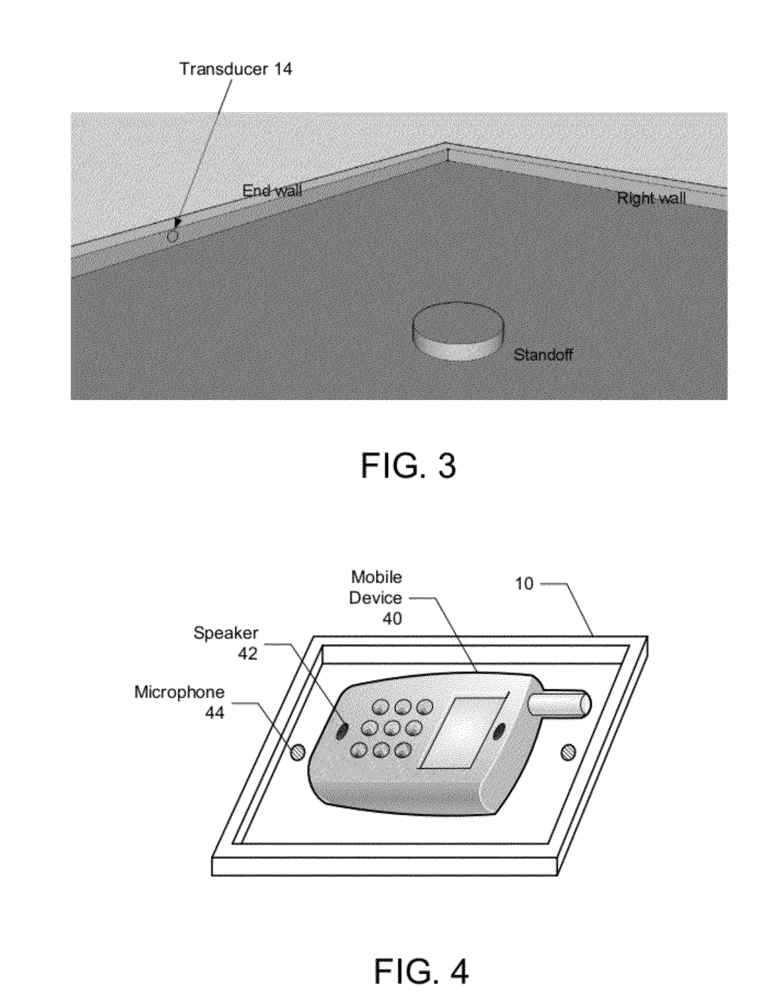

FIG. 3 is a block diagram illustrating a partial isometric view of the dock and an alternate placement for the microphone. As shown, in this embodiment the transducer 14 may be placed on the perimeter walls 20, rather than the bottom surface 18. In yet another embodiment, transducers may be placed in both the perimeter walls 20 and on the bottom surface 18.

FIG. 4 is a block diagram illustrating a mobile device placed inside a rectangular acoustic dock in accordance with one exemplary embodiment. As shown, the mobile device 40 can only be placed in the acoustic dock 10 such that the long and short sides of the mobile device 40 are parallel to the long and short sides 12, respectively, of the acoustic dock 10. In this example, the acoustic dock 10 is equipped with two microphones 44 adjacent to the two short sides of the acoustic dock 10, which line up with a speaker 42 of the device 40, and which are also typically adjacent to the short side of the mobile device 40. Because the dock has two microphones 44, acoustic data communication can still occur even if the mobile device 40 is oriented 180° in the acoustic dock 10.

In an alternative embodiment, the shape dimensions of the acoustic dock 10 may vary without departing from the scope and spirit of the exemplary embodiment. For example, the overall height of the dock and the depth of the interior perimeter walls 20 may be much greater than described above, such that the acoustic dock 10 forms an open box around an inserted mobile device, for instance.

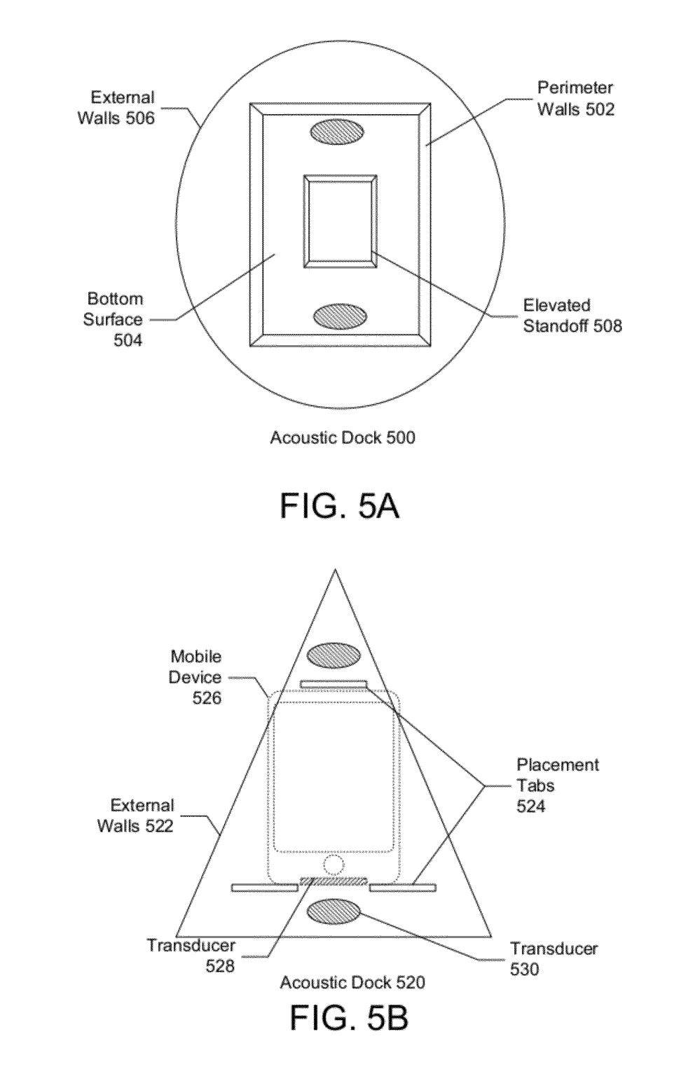

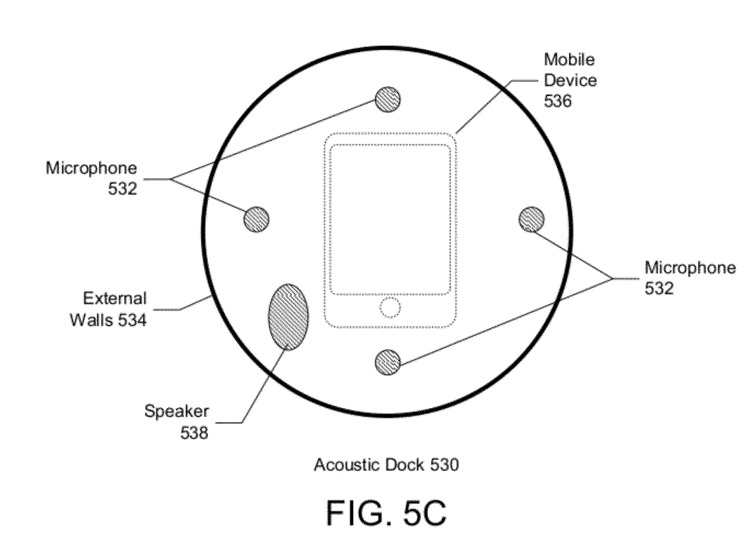

FIGS. 5A-5C are block diagrams illustrating alternative embodiments for the shape and configuration of the acoustic dock. FIG. 5A illustrates a top view of an acoustic dock 500 in an embodiment where the acoustic dock 500 is configured so that the shape of perimeter walls and the external walls are different from one another. In this embodiment, the perimeter walls 502 and the bottom surface 504 form a receptacle for the mobile device that is rectangular in shape, while the an external wall 506 is circular or oval. This embodiment also shows a single rectangular standoff 508, rather than dual circular standoffs.

FIG. 5B illustrates a top view of the acoustic dock 520 in an embodiment where the acoustic dock 520 is configured with external walls 522 in a triangular shape, and instead of internal walls forming a mobile device receptacle, placement tabs 524 are affixed to the bottom 56 surface that guide and hold a mobile device 526 (dotted lines) in place. As shown, when the mobile device 526 is placed between the placement tabs 524, a transducer 528 (e.g., speaker) of the mobile device 526 is held adjacent and in proximity to a transducer 530 (e.g., microphone) of the acoustic dock 520.

FIG. 5C is a block diagram illustrating an alternative embodiment for the shape and configuration of the acoustic dock using both microphones and a speaker transducers. In this configuration, the acoustic dock 530 comprises a bottom surface for holding a mobile device without a receptacle and four microphones are arranged in a pattern while the external wall 534 is circular. This configuration allows for effective acoustic data from devices that may differ in shape from common mobile devices. The addition of a speaker transducer allows advanced scenarios such as duplex acoustic data transfer, data transfer feedback, or audible user guidance.

In each embodiment shown, the acoustic dock is able to receive a mobile device without the need for an electrical connection between any electrical contacts on the acoustic dock and any electrical contacts on the mobile device, as is typical with conventional docs for mobile devices such as for the iPhone, for example.

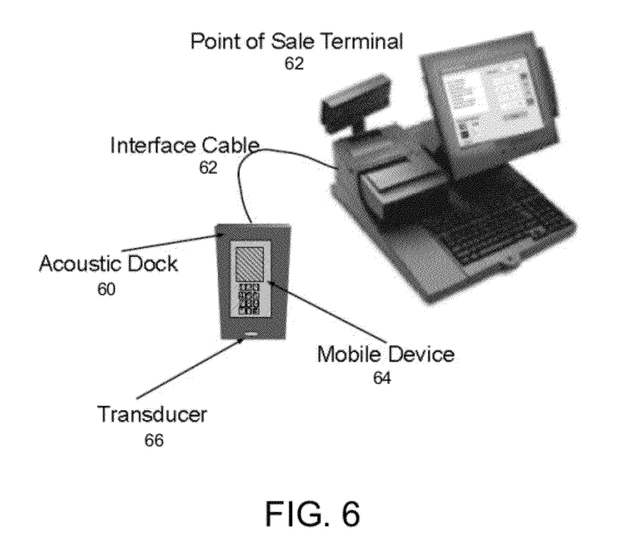

FIG. 6 is a block diagram illustrating an example usage of the acoustic dock. In this example, an acoustic dock 60 is coupled to a point-of-sale (POS) terminal 62 to transmit an acoustic carrier signal received from the mobile device 64 to the POS terminal 62. An example use is to facilitate payment transactions in which payment data is transmitted from a user's mobile device 64 over a modulated acoustic carrier signal. The acoustic dock 60 is coupled to the POS terminal 62 via a data interface cable 62, which in turn, may be coupled to the transducers 66, e.g., microphones, in the acoustic dock 60. The data interface cable 62 may comprise a simple audio cable, a USB cable the like.

Although the exemplary embodiment is being described in terms of the mobile device transmitting an acoustic signal to a microphone of the acoustic dock 10, nothing prevents reverse acoustic data can communication where the acoustic dock 10 includes a speaker that transmits an acoustic signal that is received by a microphone of the mobile device.

In further embodiments, the acoustic dock may be configured lay flat on a counter. In another embodiment, the acoustic dock may be provided with a swivel base that enables the acoustic dock to be rotated. In another embodiment, the back of the acoustic dock may be provided with a fixed or a rotatable arm that when engaged, enables the acoustic dock to sit on a countertop in an angled position.

A method and system for a method and system for providing a dock that enables efficient acoustic data transfer has been disclosed. The present invention has been described in accordance with the embodiments shown, and there could be variations to the embodiments, and any variations would be within the spirit and scope of the present invention. Accordingly, many modifications may be made by one of ordinary skill in the art without departing from the spirit and scope of the appended claims.

We claim:

1. An acoustic dock, comprising:
a bottom surface;
a plurality of sides attached to the bottom surface for receiving a mobile device having a transducer; and
one or more transducers placed in proximity to at least one of the plurality of sides, where the acoustic dock is configured to assist orientation of the mobile device in the acoustic dock so that the mobile device transducer is adjacent to and in proximity to the one or more transducers of the acoustic dock to facilitate acoustic data communication.

2. The acoustic dock of claim 1 further comprising one or more elevated standoffs located on the bottom surface that protrude upwards from the bottom surface to provide an acoustical gap between the mobile device and the bottom surface of acoustic dock.

3. The acoustic dock of claim 1 wherein the one or more transducers comprise a first microphone placed in proximity to a first one of the plurality of sides.

4. The acoustic dock of claim 3 wherein the one or more transducers comprise a second microphone placed in proximity to a second one of the plurality of sides.

5. The acoustic dock of claim 4 wherein the microphones are flush with the bottom surface.

6. The acoustic dock of claim 1 wherein the plurality of sides extend a vertical distance past the bottom surface to form elevated interior perimeter walls around the bottom surface to aid in retaining the mobile device once placed in the acoustic dock and to contain an acoustic carrier signal transmitted between the mobile device and the acoustic dock to enhance audio capture.

7. The acoustic dock of claim 6 wherein the microphones are placed on the interior perimeter walls.

8. The acoustic dock of claim 1 wherein the acoustic dock is coupled to a point-of-sale terminal via a data interface cable to transmit an acoustic carrier signal received from the mobile device to the point-of-sale terminal.

9. The acoustic dock of claim 1 wherein the acoustic dock transducer comprises a speaker.

10. The acoustic dock of claim 1 wherein the sides comprise interior perimeter walls around the bottom surface, and external walls.

11. The acoustic dock of claim 10 wherein the acoustic dock is configured so that a shape of interior perimeter walls and the external walls are different from one another.
